(19) United States
(12) Patent Application Publication
(10) Pub. No.: US 2026/0029779 A1
(43) Pub. Date: Jan. 29, 2026

(54) INTER-NETWORK COMMUNICATION

(71) Applicant: Honeywell International Inc., Charlotte, NC (US)

(72) Inventors: Mandar Vartak, Bangalore (IN); Peter Hart, KELLS MEATH (IE)

(21) Appl. No.: 18/783,458

(22) Filed: Jul. 25, 2024

(51) Int. Cl. G05B 19/418

(52) U.S. Cl. CPC G05B 19/4183; G05B 19/4185

(57) ABSTRACT

Techniques for inter-network communication are described. In response to initiation of a transaction between a first node in a first network and a second node in a second network, an attribute associated with an industrial asset linked to the first node to be communicated to the second node is determined. The attribute includes an identification parameter, an operational parameter, and an optimization parameter of the industrial asset. The transaction includes a modification request for modifying the attribute of the industrial asset from the second node. The transaction is authenticated to ascertain compliance of the second node with a predefined protocol for permitting the second node to modify the attribute of the industrial asset. In response to the authentication of the transaction, an attribute modification signal permitting the modification of the attribute of the industrial asset is generated. The attribute modification signal is transmitted to the first node.

### BACKGROUND

Industries, such as refinery, metal and mining, petrochemicals and chemicals, operate through a sequence of continuous or non-continuous industrial processes. These industrial processes can include, for example, manufacturing, product handling, production, and distribution, and may involve managing, coordinating, and streamlining operations of a variety of associated systems and devices, such as sensors, actuators, and controllers, part of the industrial setup and involved in the execution of these processes. Industrial control systems may be used to control such industrial processes and the associated systems and devices. As an example, industrial control systems include supervisory control and data acquisition (SCADA) systems to monitor and control operations of the industrial processes.

### SUMMARY

A system comprises a processor to determine an attribute associated with an industrial asset linked to a first node in a first network to be communicated to a second node in a second network, in response to initiation of a transaction between the first node and the second node. The attribute may include at least one of an identification parameter, an operational parameter, and an optimization parameter of the industrial asset. The transaction may include a modification request for modifying the attribute of the industrial asset from the second node. The first network may be, for example, an operational Technology Network (OTN) and the second network may be, for example, an Information Technology Network (ITN). The processor may authenticate the transaction initiated by the second node to ascertain compliance of the second node with a predefined protocol for permitting the second node to modify the attribute of the industrial asset. Further, the processor may generate, in response to the authentication of the transaction, an attribute modification signal permitting the modification of the attribute of the industrial asset. Furthermore, the processor may transmit the attribute modification signal to the first node instructing the first node to modify the attribute of the industrial asset.

The processor is to validate the modification request against a set of rules to determine the syntax of the modification request. The set of rules may include at least one of a range of acceptable values for the attributes, a schedule for when modifications can be made, a list of authorized users, and a list of authorized devices. Further, the processor may parse the modification request to determine an input parameter therein and may verify the input parameter against the set of rules.

In an example, to validate the modification request, the processor may identify an unsafe character in the modification request and may sanitize the modification request for removing the unsafe character from the modification request. In addition, to generate the attribute modification signal, the processor may identify a request-acceptance mode for processing the modification request for updating the attribute of the industrial asset. The request-acceptance mode may be identified from a manual mode, an auto-accept mode, or a semi-auto-accept mode.

In response to identifying the request-acceptance mode as the semi-auto-accept mode, the processor may automatically accept the modification request for updating the attribute of the industrial asset in the semi-auto accept mode after lapse of a predetermined time-period.

In an example, the processor may maintain an acknowledgement log for the industrial asset. The acknowledgement log may include at least one of an asset attribute modification request information, an accept information, and a reject information. The processor may update, in response to the attribute modification signal having been generated, the acknowledgement log and may render the updated acknowledgement log to at least one of the first node and the second node.

In an example, a method may include receiving a request for modifying an attribute of an industrial asset on a first node in a first network from a second node in a second network. The attribute of the industrial asset may be sourced from one or more control systems associated with the industrial asset to monitor and manage the industrial asset. The attribute may be indicative of at least one parameter associated with at least one of an operation, identification, and performance of the industrial asset. The first network may be an information technology network (ITN). The second network may be an operational technology network (OTN).

The method may include authenticating the request received by the second node to ascertain compliance of the second node with a predefined protocol for permitting the second node to modify the attribute of the industrial asset. Further, the method may include generating an attribute modification signal permitting the modification of the attribute of the industrial asset in response to the authentication of the request. In addition, the method may include transmitting the attribute modification signal to the first node instructing the first node to modify the attribute of the industrial asset.

In an example, in response to the authentication of the request, the method may include validating the request against a set of rules to determine the syntax of the request for modifying the attribute. The set of rules may include at least one of a range of acceptable values for the attributes, a schedule for when modifications can be made, a list of authorized users, and a list of authorized devices. Further, to validate the request, the method may include parsing the modification request to determine an input parameter therein and verifying the input parameter against the set of rules.

In an example, to validate the request, the method may include identifying an unsafe character in the request and sanitizing the request for removing the unsafe character from the request.

To generate the attribute modification signal, the method may include identifying a request-acceptance mode for processing the request for modifying the at least one attribute of the industrial asset. The request-acceptance mode may be identified from one of a manual mode, an auto-accept mode, and a semi-auto-accept mode. In response to identifying the request-acceptance mode as the semi-auto-accept mode, the method may include automatically accepting the modification request for modifying the at least one attribute of the industrial asset in the semi-auto accept mode after lapse of a predetermined time-period.

In addition, the method may include maintaining an acknowledgement log for the industrial asset. The acknowledgement log may include at least one of an asset attribute modification request information, an accept information, and a reject information. Further, the method may include updating the acknowledgement log in response to the attribute modification signal having been generated and rendering the updated acknowledgement log to the first node and/or the second node.

In an example, a non-transitory computer-readable medium may comprise instructions. The instructions may be executable by a processing resource to transmit, from within an information technology network (ITN), a first request for modifying an attribute of an industrial asset. The industrial asset may be monitored and managed from within an operational technology network (OTN). The first request may include an input parameter indicative of a modified attribute of the industrial asset. The instructions may be executable by the processing resource to receive an acknowledgment message indicative of an authentication status of the request for compliance or non-compliance of the first request with a predefined protocol permitting the modification of the attribute. The instructions may be executable by the processing resource to re-transmit, from within the information technology network (ITN), a second request for modifying the attribute in response to the acknowledgement message indicating the non-compliance of the first request. The second request may be revised over the first request attribute of the industrial asset for compliance of the second request with the predefined protocol permitting the modification of the attribute. The instructions may be executable by the processing resource to receive an acknowledgement log for the industrial asset in response to compliance of the second request with the predefined protocol permitting the modification of the attribute. The acknowledgement log may include an indication of acceptance of the second request and the modified attribute for the industrial asset. The attribute may be indicative of at least one parameter associated with at least one of an operation, identification, and performance of the industrial asset. The predefined protocol may include security measures for authenticating the first request and the second request.

### BRIEF DESCRIPTION OF DRAWINGS

The detailed description is provided with reference to the accompanying figures. In the figures, the left-most digit(s) of a reference number identifies the figure in which the reference number first appears. The same numbers are used throughout the drawings to reference like features and components.

FIG. 1 illustrates a system for inter-network communication, according to an example implementation of the present subject matter.

FIG. 2 illustrates a system for inter-network communication, according to an example implementation of the present subject matter.

FIG. 3 illustrates a system for inter-network communication, according to an example implementation of the present subject matter.

FIG. 4 illustrates a method for inter-network communication, according to an example implementation of the present subject matter.

FIG. 5 illustrates a method to validate a modification request for modifying an attribute of an industrial asset, according to an example implementation of the present subject matter.

FIG. 6 illustrates a method for processing a modification request for modifying an attribute of an industrial asset, according to an example implementation of the present subject matter.

FIG. 7 illustrates a method for updating an acknowledgement log corresponding to modification of an attribute of an industrial asset, according to an example implementation of the present subject matter.

FIGS. 8 and 9 illustrate an interface for rendering an indication of the modification request, according to an example implementation of the present subject matter.

FIG. 10 illustrates an interface for rendering an acknowledgement log, according to an example implementation of the present subject matter.

FIG. 11 illustrates a method for inter-network communication, according to an example implementation of the present subject matter.

FIG. 12 illustrates a method for inter-network communication, according to an example implementation of the present subject matter.

FIG. 13 illustrates a computing environment, implementing a non-transitory computer-readable medium for inter-network communication, according to an example implementation of the present subject matter.

### DETAILED DESCRIPTION

Industrial processes are generally implemented using industrial control systems which may involve monitoring, managing, and streamlining operations of a variety of devices in one or more facilities of an industry. Within a facility, the operation of the various associated systems and devices may be monitored, managed, and/or controlled, for instance, in real time. In an example, a large number of assets pertaining to different industrial processes may be monitored and controlled. The assets may be, for example, furnaces, blowers, machinery, conveyor belts, and motors used in an industrial plant. Each asset may include attributes, such as process parameters, control parameters, and/or optimization parameters for regulatory and for broad-level control as well as fine-tuned control of the asset.

Generally, the industrial facility may be operationally divided over two networks, namely, a process control network (PCN), and a business network (BN). The PCN, often also referred to as an operational technology network (OTN), includes programmable systems and/or devices that may interact with the assets or may manage the programmable systems/and or devices that interact with the assets. In other words, the OTN includes and/or manages systems/devices that detect or cause a direct change through the monitoring and/or control of devices, processes, and assets within an industrial setup or facility. The BN, also referred to as the information technology network (ITN), can be used by various stakeholders to monitor and view the status of the industrial facility. Based on the monitoring, the stakeholders may modify the status of the industrial facility.

Therefore, in the industrial setup, from the viewpoint of the network, the industrial processes may be controlled, from within the OTN, by information systems, referred to as control systems, such as Distributed Control Systems (DCS), Safety Instrumented Systems (SIS), and/or field devices. The status information of the assets from various control systems may be collected and shared to other computing devices which are either installed within the OTN or other networks, such as ITN, that are remote to the OTN.

Generally, access to the OTN may be separated from the ITN for sake of security. For instance, the access for the ITN to the OTN may be through a gateway to prevent editing or modification of the information on the OTN by a node on the ITN. As an example, modification of the information on the OTN for a particular asset with erroneous information may adversely affect the performance and operation of the asset pertaining to different industrial processes. Owing to security threats to which firewalls and proxies between the ITN and the OTN may be exposed, a device functioning in the ITN can only have viewing rights for devices on the OTN. In other words, the device in the ITN may be operated by user personnel, such as engineers, planners, advanced process control (APC) engineers, process engineers, and instrumentation engineers, and have access to the information, such as attributes of the asset on the OTN. However, the device in the ITN may not have the rights to modify the information in the OTN for the device in the ITN may not be recognized and trusted by the OTN. Therefore, being located in the ITN, though the device may be able to monitor the attributes associated with the asset and any event associated with the asset, the device may not have the rights to modify the attributes of the asset.

There still may be certain scenarios in which, a device having control and optimization packages, in ITN, may be interested in setting targets to controllers associated with an asset installed in OTN. However, owing to the lack of flexibility for the devices in the ITN to modify the information on the OTN, the existing techniques may tend to increase the complexity in operational management of the assets of the industrial facility in the OTN. Lack of incorporation of modifications in the attributes of the assets proposed by the device in the ITN may lead to deterioration in the performance and quality control of the process and products being generated in the industry. In an example, the modification may be essential for the proper functioning of the asset.

The present subject matter relates to techniques for managing industrial assets by regulating communications between set of nodes functioning in an information technology network (ITN) and an operational technology network (OTN) within any industrial facility implementing an industrial process. According to one exemplary embodiment, the present subject matter describes securely managing industrial assets across distinct networks upon receiving a request to modify an asset's attribute from a node in ITN. Upon receiving the request, the request may be authenticated to ensure its compliance with predefined protocols. In an example, the predefined protocols may be established to permit modifications from the requesting node and may involve various security checks to prevent unauthorized access or changes to the industrial asset. An attribute modification signal may be generated upon successful authentication and the signal may be transmitted to a node in OTN to execute the modification as requested by the node in ITN.

In accordance with the present subject matter, a system is designed to facilitate secure and controlled transactions between nodes in distinct networks, specifically focusing on the modification of attributes related to an industrial asset, may perform several functions to ensure the integrity and authorization of the transactions. Upon initiation of a transaction between a first node in a first network and a second node in a second network, which may involve a request to modify an attribute of an industrial asset, an attribute associated with an industrial asset may be determined. The attribute may be linked to the first node to be communicated to the second node. In an example, the attribute may include identification parameters, operational parameters, or optimization parameters of the industrial asset.

The system may authenticate the transaction to ensure that the second node, initiating the request, complies with a predefined protocol that may permit the second node to modify the attribute of the industrial asset. Once the transaction is authenticated, an attribute modification signal permitting the modification of the attribute of the industrial asset may be generated. The attribute modification signal may then be transmitted to the first node, instructing it to carry out the modification. In an example, the first node may be a part of an Operational Technology Network (OTN), while the second node may be a part of an Information Technology Network (ITN).

In an example implementation, a requesting node, such as the second node in the ITN, may enable various operations that facilitate the modification of attributes of the industrial asset. For instance, the industrial asset may be monitored and managed within the OTN, and the modification requests may originate from within an ITN. A first request may be transmitted from the ITN to modify an attribute of the industrial asset. The first request may include an input parameter indicative of the desired modification to the attribute of the industrial asset.

Upon transmitting the first request, the requesting node may receive an acknowledgment message. In an example, the acknowledgment message may provide information regarding the authentication status of the first request, indicating whether the first request is compliant or non-compliant with a predefined protocol that governs the modification of the asset's attribute. In a scenario, when the first request is found to be compliant with the predefined protocol, the attribute of the industrial asset may be updated with a modified attribute associated with the input parameter. Alternatively, in an event when the first request is found to be non-compliant with the predefined protocol, the first request may be rejected and the attribute of the industrial asset may remain unchanged and may not get updated based on the specified input parameter by the requesting in the ITN. For instance, the modification request may be rejected in case the modification has been requested from an untrusted or an unrecognized node. The modification request may also be rejected when such modification would result in deterioration in the performance of the industrial processes.

In an example, the requesting node may re-transmit a second request. The second request may be a revised version of the first request. The second request may be adjusted to ensure compliance with the predefined protocol, thereby addressing the reasons for the non-compliance of the initial first request. In response to the compliance of the second request with the predefined protocol, the attribute of the industrial asset may be updated with a modified attribute associated with the second request. The requesting node may receive an acknowledgment log. The acknowledgement log may include an indication that the second request has been accepted and that the modification to the attribute of the industrial asset has been implemented.

In an example, an unsafe character in the modification request may be identified and sanitized to validate the modification request. For instance, the modification request may be parsed to determine an input parameter therein. Further, the input parameter may be verified against a set of rules. Further, an unsafe character in the modification request may be identified. The modification request may be sanitized to remove the unsafe character from the modification request. This may be performed to eliminate any harmful effects caused to the industrial assets and/or the industrial processes due to the presence of unsafe characters.

The present subject matter may thus provide secure techniques for modifications in the industrial assets using authentication-based writes from the ITN to the OTN. An operator device in the OTN may approve the asset attribute modification requests made by set of nodes from ITN upon successful authentication, thereby ensuring accountability of the asset. The acknowledgement log in the present subject matter may record modification request information, acceptances, and rejections, thereby creating an audit trail. The acknowledgement log may be used for tracking changes, troubleshooting issues, and ensuring accountability for modifications made to the industrial asset's attributes. Further, the present subject matter provides techniques for digitization of modifications to asset attributes from ITN to OTN, thus enhancing the auditability of the technique. In addition, the operator device may time the acceptance of the modification request based on underlying industrial process conditions. The present techniques may thus be capable of allowing secure, timely, and robust control and optimization of assets in a topology in which different networks, such as the OTN and the ITN are interconnected.

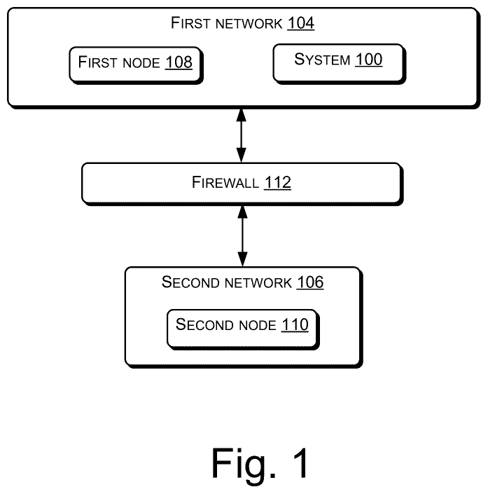

The present subject matter is further described with reference to FIGS. 1-13. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a system 100 for inter-network communication, according to an example implementation of the present subject matter. A first network 104 may, for example, include wireless networks, wireless Local Area Network (WLAN), RAN, satellite-based network, and the like. Similarly, the second network 106 may, for example, include wireless networks, wireless Local Area Network (WLAN), RAN, satellite-based network, and the like.

The first network 104 may include a first node 108 that may control or interact with devices or assets within the first network 104. The first network 104 may be part of an industrial facility. The devices or assets within the first network 104 may be, for example, an industrial asset, such as furnaces, blowers, machinery, conveyor belts, motors, and the like, used in an industrial plant. The first node 108 may be or may include a computing device that has processing capabilities, such as a server, a desktop, a laptop, a tablet, a mobile phone, or the like. For instance, the first node 108 may include, for example, a microprocessor, a microcomputer, a microcontroller, a digital signal processor, a central processing unit, a state machine, a logic circuitry, or a device that manipulates signals based on operational instructions. The first node 108 may include a processing unit (not shown in FIG. 1), a memory (not shown in FIG. 1), and an interface.

Further, in an example, a second network 106 may be, for example, remote from the first network 104. The second network 106 may be part of industrial facility. The second network 106 may include a second node 110 that may be or may include devices that are to enable monitoring status of industrial assets within the first network 104. For instance, the second node 110 may request modification of an attribute associated with a furnace, which may be managed by the first node 108.

The second node 110 may be or may include a computing device that has processing capabilities, such as a server, a desktop, a laptop, a tablet, a mobile phone, or the like. For instance, the second node 110 may include, for example, a microprocessor, a microcomputer, a microcontroller, a digital signal processor, a central processing unit, a state machine, a logic circuitry, or a device that manipulates signals based on operational instructions. The second node 110 may include a processor (not shown in FIG. 1), a memory (not shown in FIG. 1), and an interface. In an example, in addition to the monitoring of the status of the asset of the industrial facility, the second node 110 may, for example, request modification of an attribute of an industrial asset that is within the first network 104. Particularly, the second node 110 may request modification of an attribute of an industrial asset that may be linked to and/or controlled by the first node 108. For instance, assume that a conveyor belt is linked to and controlled by the first node 108. An engineer may monitor the attributes, such as process parameters, process parameters, control parameters, and/or optimization parameters, corresponding to the conveyor belt through the second node 110. Further, the engineer may want to increase the speed of the conveyor belt. Accordingly, the engineer may, through the second node 110, be able to request modification of an attribute of the conveyor belt.

In an example, access to the first network 104 may be separated from the second network 106 for sake of security. The access for the second network 106 to the first network 104 may be through a gateway, such as a firewall 112, to prevent editing or modification of the information on the first network 104 by the second node 110 on the second network 106. In this regard, a system 100 may facilitate secured and controlled transactions between the first node 108 and the second node 110 while also processing a request, from the second node 110, for modification of the attributes related to the industrial asset that is controlled by the first node 108.

In this regard, the system 100 may determine an attribute associated with the industrial asset linked to the first node 108 to be communicated by the second node 110. The determination of the attribute associated with the industrial asset may be performed in response to a modification request for modifying the attribute of the industrial asset from the second node 110. The system 100 may authenticate the transaction initiated by the second node 110 to ascertain compliance of the second node 110 with a predefined protocol for permitting the second node 110 to modify the attribute of the industrial asset.

The system 100 may generate an attribute modification signal permitting the modification of the attribute of the industrial asset in response to the authentication of the modification of the attribute of the industrial asset. Further, the system 100 may transmit the attribute modification signal to the first node 108 instructing the first node 108 to modify the attribute of the industrial asset. Therefore, the system 100 may enable processing of the request for the modification of the attribute from the second node 110 to modify the attribute of the industrial asset linked with the first node 108.

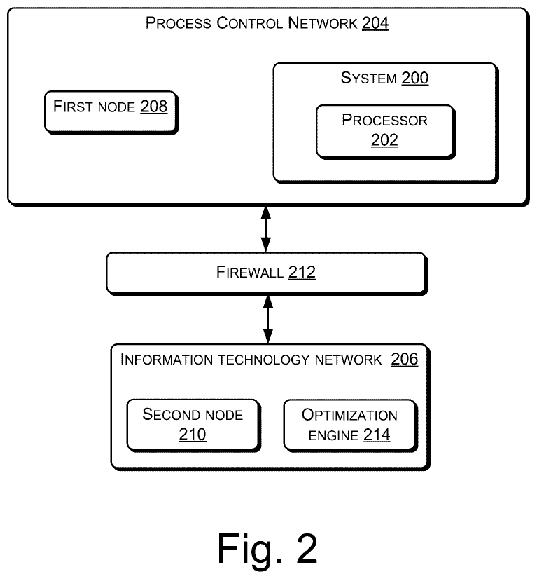

FIG. 2 illustrates a system 200 for inter-network communication, according to an example implementation of the present subject matter. The system 200 may correspond to the system 100. A first network 204 may correspond to the first network 104. The first network 104 may, for example, include wireless networks, wireless Local Area Network (WLAN), RAN, satellite-based network, and the like. Similarly, the second network 106 may, for example, include wireless networks, wireless Local Area Network (WLAN), RAN, satellite-based network, and the like.

The first network 204 may be part of an industrial facility. For instance, the first network 204 may be a process control network (PCN). Hereinafter, the PCN will be referred to as operational technology network (OTN). The OTN 104 may include a first node 208. The first node 208 may be, for example, a programmable device that may interact with assets of an industrial facility or a device that may manage the programmable devices that interact with the assets of the industrial facility. The devices or assets within the OTN 204 may be, for example, an industrial asset, such as furnaces, blowers, machinery, conveyor belts, motors, and the like, used in an industrial plant. The OTN 204 may include and/or may manage devices that detect or cause a direct change through monitoring and/or control of devices, processes, and assets within the industrial facility, especially within the OTN 204. In an example, the first node 208 may be, for example, information devices, referred to as control devices, such as Distributed Control Systems (DCS), Safety Instrumented Systems (SIS), and/or field devices. The industrial processes may be controlled, from within the OTN 204, by the first node 208. The status information of the assets from various control systems may be collected and shared to other computing devices which are either installed within the OTN 204 or other networks.

In an example, the first node 208 may be or may include a computing device that has processing capabilities, such as a server, a desktop, a laptop, a tablet, a mobile phone, or the like. For instance, the first node 208 may include, for example, a microprocessor, a microcomputer, a microcontroller, a digital signal processor, a central processing unit, a state machine, a logic circuitry, or a device that manipulates signals based on operational instructions. The first node 208 may include a processor (not shown in FIG. 1), a memory (not shown in FIG. 1), and an interface. For example, assume that the first node 208 corresponds to a control device to control a furnace. The control device may control various parameters, such as steam temperature, steam pressure, and the like. The first node 208 may correspond to the first node 108.

A second network 106 may be a business network (BN). The second network 206 may correspond to the second network 106. The BN may be referred to as the information technology network (ITN). The ITN 206 may be remote to the OTN 204. The ITN 206 may be used by various stakeholders to monitor status of the assets of the industrial facility, specifically the assets controlled by and/or linked with the first node 208. Based on the monitoring, the stakeholders may modify the status of the industrial facility.

The second node 210 may be or may include devices that are to enable monitoring status of an asset of the industrial facility. In an example, the second node 210 may be or may include a computing device that has processing capabilities, such as a server, a desktop, a laptop, a tablet, a mobile phone, or the like. For instance, the second node 210 may include, for example, a microprocessor, a microcomputer, a microcontroller, a digital signal processor, a central processing unit, a state machine, a logic circuitry, or a device that manipulates signals based on operational instructions. The second node 210 may include a processor (not shown in FIG. 2), a memory (not shown in FIG. 2), and an interface. In an example, the second node 210 may, for example, request modification of an attribute of an industrial asset that is controlled by the first node 208. For instance, assume that an engineer is monitoring status of the heating process inside a furnace through the second node 210 and that the furnace is controlled by the first node 208. To have an enhanced heating, the engineer may want to change operating temperature of the furnace. In this regard, the engineer may use the second node 210 to request for modification of the operating temperature of the furnace to the first node 208. In an example, the second node 210 may correspond to the second node 110.

In another example, the ITN 206 may include optimization engine 214, that may include control and optimization programs residing in the ITN 206 of the organization either on-prem or cloud, may also raise a modification request to modify an attribute of the industrial asset. For instance, the optimization engine 214 may want to set a target corresponding to the attribute of the industrial asset that is linked to the first node 208. Assume that the first node 208 controls an electric motor. Further, assume that the optimization engine 214 may want to set speed of the shaft of the electric motor to a predetermined value after a predetermined time of operation of the electric motor. Accordingly, the optimization engine 214 may request modification of the attribute of the electric motor after the predetermined time of operation of the electric motor.

In an example, access to the OTN 204 may be separated from the ITN 206 for sake of security. The access for the ITN 206 to the OTN 204 may be through a gateway, such as a firewall 212, to prevent editing or modification of the information on the OTN 204 by the second node 210 on the ITN 206. In this regard, the system 200 may facilitate secured and controlled transactions between the first node 208 and the second node 210 while also processing a request, from the second node 210, for modification of the attributes related to the industrial asset that is controlled by the first node 208.

In this regard, the system 100 may include a processor 202. The processor 202 may determine an attribute associated with the industrial asset linked to the first node 208 to be communicated by the second node 210. The determination of the attribute associated with the industrial asset may be performed in response to a modification request for modifying the attribute of the industrial asset from the second node 210. The processor 202 may authenticate the transaction initiated by the second node 210 to ascertain compliance of the second node 210 with a predefined protocol for permitting the second node 210 to modify the attribute of the industrial asset. The processor 202 may generate an attribute modification signal permitting the modification of the attribute of the industrial asset in response to the authentication of the modification of the attribute of the industrial asset. Further, the processor 202 may transmit the attribute modification signal to the first node 208 instructing the first node 208 to modify the attribute of the industrial asset. Therefore, the system 200 may enable processing of the request for the modification of the attribute from the second node 110 to modify the attribute of the industrial asset linked with the first node 108.

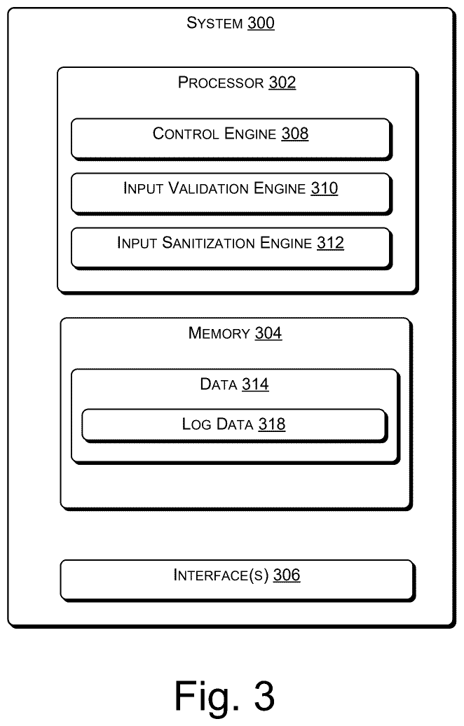

FIG. 3 illustrates a system 300 for inter-network communication, according to an example implementation of the present subject matter. The system 300 may include a computing device that has processing capabilities, such as a server, a desktop, a laptop, a tablet, a mobile phone, or the like. For instance, the system 300 may include, for example, a microprocessor, a microcomputer, a microcontroller, a digital signal processor, a central processing unit, a state machine, a logic circuitry, or a device that manipulates signals based on operational instructions. The system 300 may correspond to the system 100 or the system 200. The system 300 may include a processor 302, a memory 304, and an interface 306.

The processor 302 may run at least one operating system and other applications and services. Further, the processor 302 can include one or more engines 308, 310, 312. The processor 302, amongst other capabilities, may be configured to fetch and execute computer-readable instructions stored in the memory. The processor 302 may be implemented as one or more microprocessors, microcomputers, microcontrollers, digital signal processors, central processing units, state machines, logic circuitries, and/or any devices that manipulate signals based on operational instructions. The functions of the various elements shown in the figure, including any functional blocks labelled as “processor”, may be provided through the use of dedicated hardware as well as hardware capable of executing machine readable instructions.

When provided by the processor 302, the functions may be provided by a single dedicated processor, by a single shared processor, or by a plurality of individual processors, some of which may be shared. Moreover, explicit use of the term “processor” should not be construed to refer exclusively to hardware capable of executing machine readable instructions, and may implicitly include, without limitation, digital signal processor (DSP) hardware, network processor, application specific integrated circuit (ASIC), field programmable gate array (FPGA), read only memory (ROM) for storing machine readable instructions, random access memory (RAM), non-volatile storage. Other hardware, conventional and/or custom, may also be included.

The interface 306 may include a variety of machine-readable instructions-based interfaces and hardware interfaces that allow the system 300 to interact with different entities, such as the processor 302 and the memory 304. Further, the interface may enable the components of the system 300 to communicate with computing devices, web servers, and external repositories. The interface may facilitate multiple communications within a wide variety of networks and protocol types, including wireless networks, wireless Local Area Network (WLAN), RAN, satellite-based network, and the like.

The memory 304 may be coupled to the processor 302 and may, among other capabilities, provide data and instructions for generating different requests. The memory can include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes. The memory 304 may include data 314 corresponding to the modification of the attributes of the industrial asset.

The engines 308, 310, 312 may include routines, programs, objects, components, data structures, and the like, which perform particular tasks or implement particular abstract data types. The engines 308, 310, 312 may further include modules that supplement applications on the system 300, for example, modules of an operating system. Further, the engines 308, 310, 312 may be implemented in hardware, instructions executed by a processor, or by a combination thereof.

In an implementation, the engines 308, 310, 312 may be machine-readable instructions which, when executed by the processor 302, perform any of the described functionalities. The machine-readable instructions may be stored on an electronic memory device, hard disk, optical disk or other machine-readable storage medium or non-transitory medium. In one implementation, the machine-readable instructions can also be downloaded to the storage medium via a network connection.

The engines 308, 310, 312 may perform different functionalities. The engines 308, 310, 312 include a control engine 308, an input validation engine 310, and an input sanitization engine 312. The functions of the engines 308, 310, 312 are explained below.

In an example, the control engine 308 may receive a request from a second node in a second network for modifying an attribute of an industrial asset on a first node in a first network. For instance, assume that the first node in the first network may be lined to and/or control an electric motor that is driving an equipment. Further, assume that rotational speed of the electric motor may have to be changed to 3600 revolutions per minute (RPM) by an operator from the second node in the second network. The control engine 308 may receive a request from the second node for modifying the rotational speed of the electric motor to 3600 RPM.

The control engine 308 may determine the attribute associated with the industrial asset linked to the first node to be communicated to the second node. For instance, the control engine 308 may determine that the attribute to be modified is rotational speed of the electric motor. Further, in an example, the control engine 308 may generate an attribute modification signal permitting the modification of the attribute of the industrial asset in response to the authentication of the request for modifying the attribute of the industrial asset. In addition, the control engine 308 may also transmit the attribute modification signal to the first node. The attribute modification signal may include instructions to the first node to modify the attribute of the industrial asset. For instance, the control engine 308 may generate an attribute modification signal to modify the rotational speed of the electric motor to 3600 RPM and transmit the attribute modification signal including instructions to the first node to modify the rotational speed of the electric motor to 3600 RPM.

Further, the control engine 308 may identify a request-acceptance mode for processing the modification request for updating the attribute of the industrial asset. The request-acceptance mode may include a manual mode, an auto-accept mode, and a semi-auto-accept mode. In an auto-accept mode, the control engine 308 may be configured to automatically accept the request for modifying the attribute of the asset. For instance, in the auto-accept mode, the control engine 308 may be configured to automatically accept the request for modifying the rotational speed of the electric motor to 3600 RPM. In this regard, the system 300 may have the authorization of the asset for which the attribute is to be modified. In the semi-auto accept mode, the control engine 308 may wait for a predetermined time period upon the receipt of the request for the modification of the attribute. Upon the expiry of the predetermined time period, the control engine 308 may be configured to automatically accept the request for the modification of the attribute. For instance, the control engine 308 may wait for expiry of the predetermined time period and may automatically accept the request for modifying the rotational speed of the electric motor to 3600 RPM. In the predetermined time period, the control engine 308 may wait for the approval or rejection of the request for the modification of the attribute from the first node 108. In a manual mode, an operator is to manually monitor and control the asset attribute. In this regard, upon receiving the request for the modification, the operator may process the request for implementing or rejecting the modification of the attribute of the asset.

In addition, the control engine 308 may maintain an acknowledgement log for a plurality of industrial assets. The acknowledgement log may include at least one of an asset attribute modification request information, an accept information, and a reject information of each of the plurality of industrial assets. For instance, assume that there is a first modification request to modify a first attribute of the electric motor, a second modification request to modify a second attribute of the electric motor, and a third modification request to modify a third attribute of the electric motor. Further, assume that the first modification request has been accepted and the second modification request and the third modification request have been rejected. In this regard, the acknowledgement log may include information corresponding to the first modification request and the accept information of the first modification request. Further, the acknowledgement log may include information corresponding to the second modification request and the reject information of the second modification request. In addition, the acknowledgement log may include information corresponding to the third modification request and the reject information of the third modification request. The acknowledgement log may be stored in the log data 318 in the memory 304.

Further, the control engine 308 may update the acknowledgement log in response to the attribute modification signal having been generated. For instance, in response to the generation of the modification signal to modify the rotational speed of the electric motor to 3600 RPM, the control engine 308 may update the acknowledgment log. In other words, the control engine 308 may update information corresponding to the modification request to modify the rotational speed of the electric motor to 3600 RPM with the accept information. Further, the control engine 308 may render the updated acknowledgement log to the first node and/or the second node.

The input validation engine 310 may authenticate the request for the modification of the attribute of the industrial asset from the second node to ascertain compliance of the second node with a predefined protocol for permitting the second node to modify the attribute of the industrial asset. The input validation engine 310 may validate the modification request against a set of rules to determine the syntax of the modification request. The set of rules may include at least one of a range of acceptable values for the attributes, a schedule for when modifications can be made, a list of authorized users, and a list of authorized devices. In particular, the input validation engine 310 may parse the modification request to determine an input parameter therein. Further, the input validation engine may verify the input parameter against the set of rules. For instance, the input validation engine 310 may validate the modification request to modify the rotational speed of the electric motor to 3600 RPM against a set of rules. In other words, the input validation engine 310 may validate if 3600 RPM is an acceptable value of rotational speed of the electric motor. Further, the input validation engine 310 may validate if the second node that raised the modification request is an authorized device to request modification of the rotational speed of the electric motor. The input validation engine 310 may validate if the operator that is raise request through the second node is an authorized user to modify the rotational speed of the electric motor. Furthermore, the input validation engine 310 may validate if the modification request is requested in the time period in which the modifications can be made.

The input sanitization engine 312 may identify an unsafe character in the modification request and may sanitize the modification request for removing the unsafe character from the modification request. The sanitization of the input parameter may be done to remove any untrusted or unsafe characters from the modification request. In an example, the input sanitization engine 312 may permit the modification request with valid characters and valid code strings. The input sanitization engine 312 may modify the modification request in a valid format such that the input parameters do not cause any harmful effects in the industrial process. In an exemplary scenario, the input sanitization engine 312 may reject invalid input parameters. For instance, assume that the request to modify the rotational speed of the electric motor to 3600 RPM includes untrusted characters, such as “####”. This may be a potential malware and may cause harmful effects to the electric motor. Accordingly, the input sanitization engine 312 may either reject such invalid request or remove the untrusted characters “####” to change the modification request in a valid format.

In an example, the modification request may undergo both input validation and input sanitization. For example, the modification request may first be validated and then sanitized. The input validation and input sanitization may be implemented in all the three different request-acceptance modes for processing the received modification request.

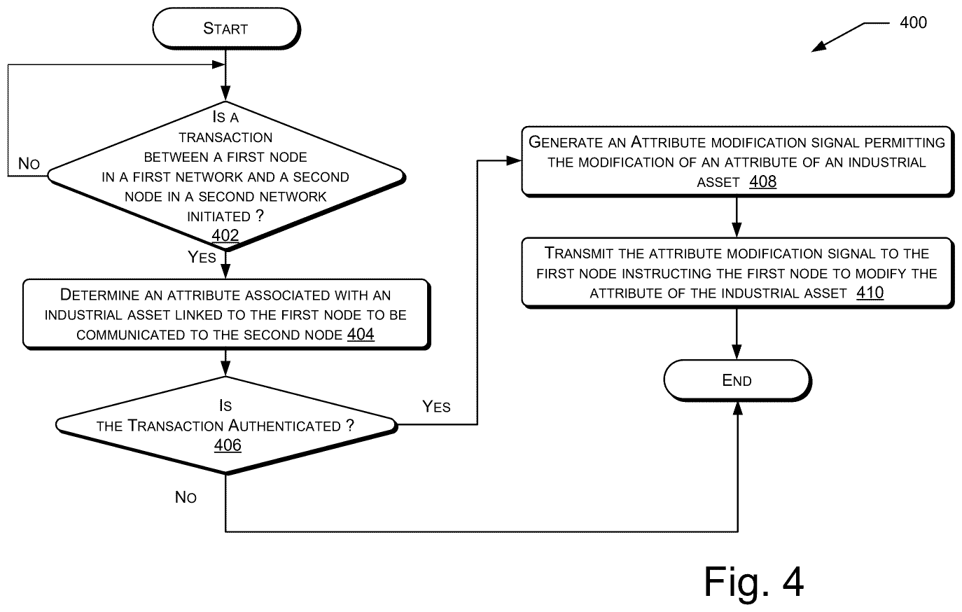

FIG. 4 illustrates a method 400 for inter-network communication, according to an example implementation of the present subject matter. The order in which the method 400 is described is not intended to be construed as a limitation, and any number of the described method blocks may be combined in any order to implement the method 400, or an alternative method. Furthermore, the method 400 may be implemented by processor(s) or computing device(s) through any suitable hardware, non-transitory machine-readable instructions, or a combination thereof.

It may be understood that steps of the method 400 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, the method 400 may be performed by the system 100, the system 200, or the system 300.

At step 402, it may be determined if a transaction between a first node in a first network and a second node in a second network is initiated. The transaction may include a modification request for modifying the attribute of the industrial asset from the second node. The industrial asset may be linked to and/or controlled by the first node. The first network may be, for example, OTN and the second network may be, for example, ITN. The first network may correspond to the first network 104 or the OTN 104. The second network may correspond to the second network 106 or the ITN 206. The first node may correspond to, for example, the first node 108, or the first node 208. The second node may correspond to, for example, the second node 110 or the second node 210. For instance, assume that a furnace in an industrial facility is controlled by the first node within the OTN. An engineer monitoring the status of the parameters corresponding to the furnace through the second node in the ITN may want to change the operating temperature of the furnace. Accordingly, the engineer may raise a request for modification of the operating temperature of the furnace, for example, to 1000° C. through the second node. In an example, the step 402 may be performed by the control engine 308.

If, at step 402, it is determined that the transaction has been initiated between the first node and the second node, the method 400 may proceed to step 404. If, at 402, it is determined that the transaction has not been initiated between the first node and the second node, the method 400 may wait till such a transaction is initiated.

At step 404, an attribute associated with the industrial asset linked to the first node to be communicated by the second node may be determined. Particularly, in response to receiving the modification request from the second node, the attribute that is associated with the industrial asset linked to the first node and that is to be modified may be determined. For instance, upon receiving the request for modification of an attribute associated with the furnace from the second node, the attribute may be determined as the operating temperature. The step 404 may be performed by the control engine 308.

At step 406, it may be determined if the transaction is authenticated. In other words, it may be determined if the modification request is authenticated to ascertain compliance of the second node with a predefined protocol for permitting the second node to modify the attribute of the industrial asset. The predefined protocol may include security measure for authenticating the request for modification. For instance, it may be determined if the second node is in compliance with a predefined protocol to allow for modifying the operating temperature of the furnace to 1000° C. and the modification request may be authenticated. If, at step 406, it is determined that the transaction is authenticated, the method 400 may proceed to step 408. If it is determined that the second node is in compliance with the predefined protocol, the modification request for modifying the operating temperature to 1000° C. may be authenticated.

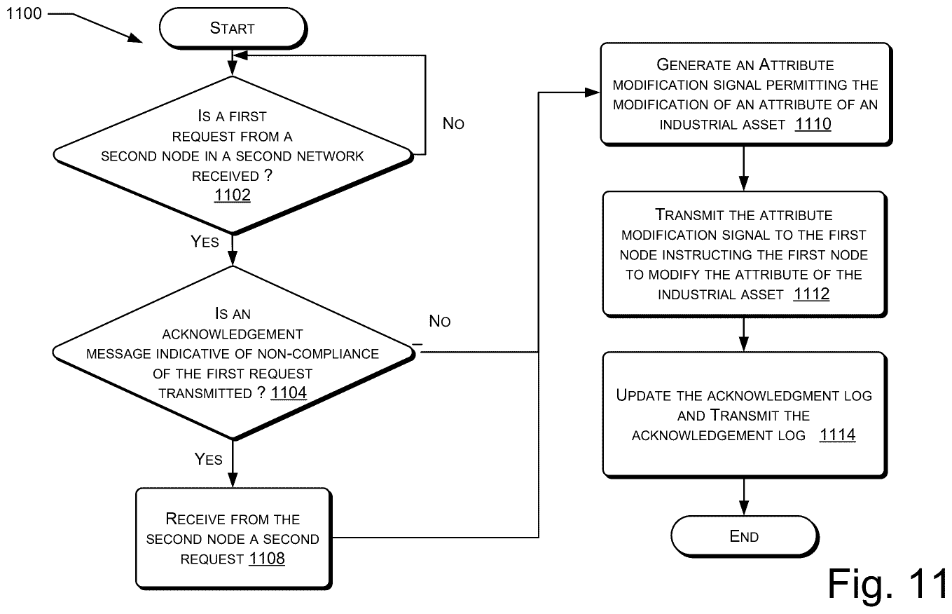

If, at step 406, it is determined that the transaction is not authenticated, then the method 400 may proceed to step 402, where a new request for modification may be transmitted by the second node. If it is determined that the second node does not comply, the modification of the operating temperature of the furnace to 1000° C. may not be permitted. Further, a new request for the modification may have to be transmitted by the second node after complying with the predefined protocol, as will be explained with reference to FIG. 11. The step 406 may be performed, for example, by the input validation engine 310.

At step 408, in response to the authentication of the modification request, an attribute modification signal may be generated. The attribute modification signal may permit the modification of the attribute of the industrial asset. For instance, in response to the authentication of the request for the modification of the operating temperature of the furnace to 1000° C., the attribute modification signal permitting may be generated. The attribute modification signal may include instructions to the first node for the modification of the operating temperature of the furnace to 1000° C. The step 408 may be performed by, for example, the control engine 308.

At step 410, the attribute modification signal may be transmitted to the first node instructing the first node to modify the attribute of the industrial asset. For instance, the attribute modification signal instructing the first node for the modification of the operating temperature of the furnace to 1000° C. may be transmitted to the first node. The first node may subsequently modify the operating temperature of the furnace 1000° C.

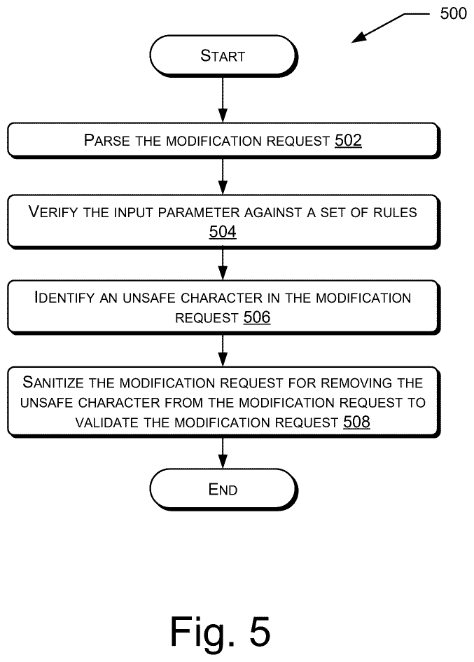

FIG. 5 illustrates a method 500 to validate the modification request for modifying the attribute of the industrial asset, according to an example implementation of the present subject matter. The order in which the method 500 is described is not intended to be construed as a limitation, and any number of the described method blocks may be combined in any order to implement the method 500, or an alternative method. Furthermore, the method 500 may be implemented by processor(s) or computing device(s) through any suitable hardware, non-transitory machine-readable instructions, or a combination thereof.

It may be understood that steps of the method 500 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, the method 500 may be performed by the system 100, the system 200, or the system 300. Herein, the validation of the modification request is explained.

At step 502, upon receiving the modification request, the modification request may be parsed to determine an input parameter therein. For instance, assume that the modification request is to modify the operating temperature of the furnace to 1000° C. Upon receiving the request from the second node, the request may be parsed to identify that the operating temperature is to be modified to 1000° C.

At step 504, the input parameter may be verified against a set of rules. The set of rules may include a range of acceptable values for the attributes, a schedule for when modifications can be made, a list of authorized users, and a list of authorized devices. For instance, assume that the range of acceptable values of the operating temperature of the furnace to is between 700° C.-1300° C. Accordingly, upon parsing the modification request, the input parameter (the operating temperature of the furnace to 1000° C.) may be verified against the range of acceptable values (range of the operating temperatures 700° C.-1300° C.). In another example, assume that the request to modify the operating temperature of the furnace to 1000° C. has been raised by an engineer through the second node. Further, assume that the engineer does not belong to the list of authorized users. Accordingly, upon parsing the modification request, the input parameter may be verified against the list of authorized users. Since the engineer does not belong to the list of authorized users, the request may not be verified. The step 502 and the step 504 may be performed by the input validation engine 310.

In an example, only valid characters and code strings may be permitted so as to ensure that the input parameters do not cause any harmful effects in the industrial asset or the industrial process. At step 506, an unsafe character in the modification request may be identified. In an example, if the modification request includes invalid input parameters, the modification request may be rejected. For instance, assume that the request may include characters “@$#” as part of the request. The characters “@$#” may be identified as unsafe characters. In an example, the request with such characters may be rejected. This may be performed as the unsafe characters could indicate malware and processing of request with such characters may cause harmful effects in the industrial process. In another example, the request with unsafe characters may be sanitized as will be explained below.

At step 508, the modification request may be sanitized for removing the unsafe characters. In other words, the modification request may modify the unsafe characters to make the input parameters in a valid format such that the input parameters do not cause any harmful effects in the industrial process. For instance, assume that the request may include unsafe characters “@$#” as part of the request. The unsafe characters “@$#” may be removed to make the input parameters in the valid format so as to eliminate any harmful effects to the industrial assets caused by such unsafe characters. The steps 506 and 508 may be performed by the input sanitization engine 312.

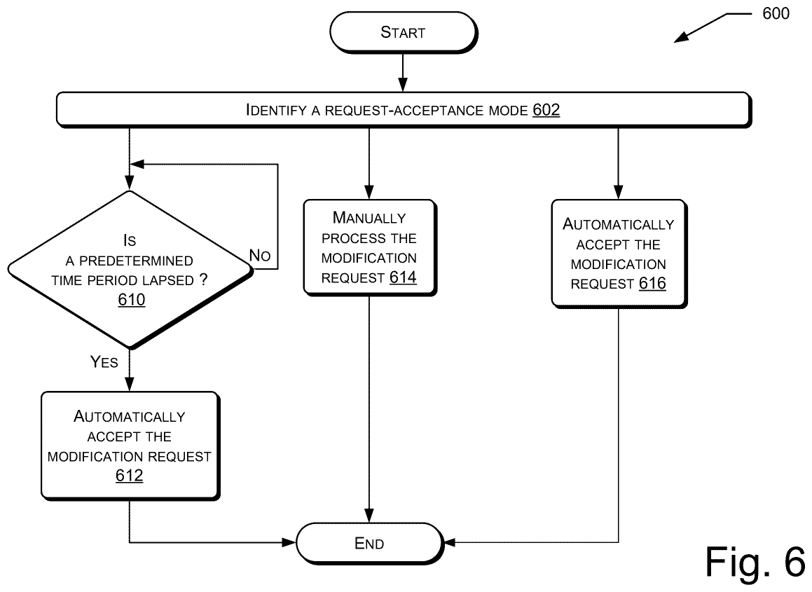

FIG. 6 illustrates a method 600 for processing the modification request for modifying the attribute of the industrial asset, according to an example implementation of the present subject matter.

The order in which the method 600 is described is not intended to be construed as a limitation, and any number of the described method blocks may be combined in any order to implement the method 600, or an alternative method. Furthermore, the method 600 may be implemented by processor(s) or computing device(s) through any suitable hardware, non-transitory machine-readable instructions, or a combination thereof.

It may be understood that steps of the method 600 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, some of the steps of the method 600 may be performed by the system 100, the system 200, or the system 300. Herein, the processing of the modification request based on various request-acceptance modes is explained.

At step 602, a request acceptance mode may be identified. The request acceptance mode may include a semi-auto accept mode, a manual mode, and an auto accept mode.

If the request-acceptance mode is identified as the semi-auto accept mode, at step 610, it may be determined if a predetermined time period has elapsed. In some examples, an operator may be owner of the industrial asset. Further, in some examples, an operator may not be an owner of the industrial asset. Accordingly, in the semi-auto accept mode, the system may wait for a predetermined time period for approval or rejection of the modification request from the first node by the operator. For instance, assume that an operating temperature of the furnace has to be modified to 1000° C. In the semi-auto accept mode, the system may wait for a predetermined time period for the approval or rejection of the request for modifying the operating temperature of the furnace to 1000° C. In the predetermined time period, the operator may approve or reject the request if he is the owner of the furnace and has the authority to modify the attributes of the furnace. Further, if the operator is not the owner, the operator may not be able to perform any action on modification of the attribute of the furnace.

If, at step 610, it is determined that the predetermined time period is elapsed, at step 612, the modification request may be automatically accepted. For instance, upon determining that the predetermined time period has elapsed, the modification request to modify the operating temperature of the furnace to 1000° C. may be automatically accepted and the operating temperature of the furnace may be changed to 1000° C. On the contrary, if at step 610, it is determined that the predetermined time period has not elapsed, the method 600 may await till the predetermined time period has elapsed.

If the request-acceptance mode has been identified as manual mode, an operator is to manually monitor and control the asset attribute. In this regard, at step 614, upon receiving the request for the modification, the operator may process the request for implementing or rejecting the modification of the attribute of the asset. For instance, assume that an operating temperature of the furnace has to be modified to 1000° C. In the manual mode, an operator may be the owner of the furnace and may have the authority to modify the attributes of the furnace. Accordingly, the operator may manually approve or reject the request for modifying the operating temperature of the furnace to 1000° C.

If the request-acceptance mode has been identified as an auto-accept mode, at step 616, the system may be configured to automatically accept the request for modifying the attribute of the asset. In this regard, the system may have the authorization of the asset for which the attribute is to be modified. For instance, assume that an operating temperature of the furnace has to be modified to 1000° C. In the auto-accept mode, the system may be configured to automatically accept the request for modifying the operating temperature of the furnace to 1000° C. Upon accepting the modification request in all the request-acceptance modes, the system may perform validation of the modification request and sanitization of the modification request, as is explained with reference to FIG. 5.

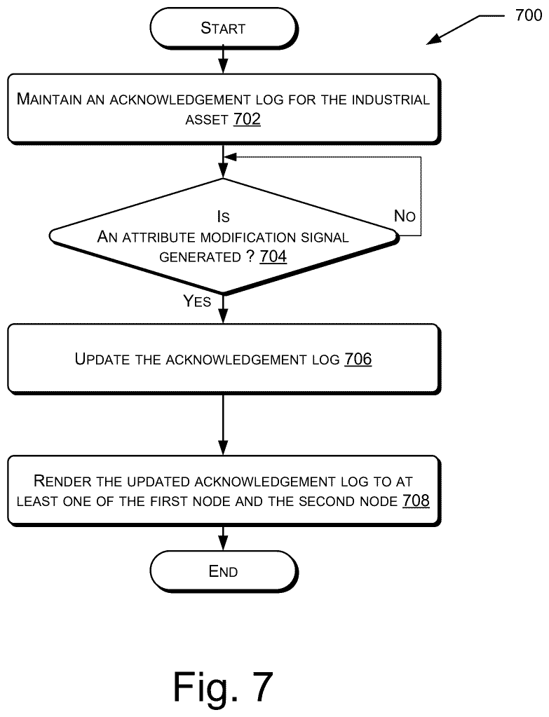

FIG. 7 illustrates a method 700 for updating an acknowledgement log corresponding to modification of an attribute of an industrial asset, according to an example implementation of the present subject matter.

The order in which the method 700 is described is not intended to be construed as a limitation, and any number of the described method blocks may be combined in any order to implement the method 700, or an alternative method. Furthermore, the method 700 may be implemented by processor(s) or computing device(s) through any suitable hardware, non-transitory machine-readable instructions, or a combination thereof.

It may be understood that steps of the method 700 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, some of the steps of the method 700 may be performed by the system 100, the system 200, or the system 300.

At step 702, an acknowledgement log may be maintained for the industrial asset. The acknowledgement log may include at least one of an asset attribute modification request information, an accept information, and a reject information. For instance, assume that a first modification request for modifying an operating temperature of the furnace to 3000° C. was requested. Further, the first modification request was rejected. Further, assume that a second modification request for modifying an operating pressure of the furnace to 1 bar pressure and that the second modification request was accepted and implemented. The acknowledgement log may include the first modification request and the reject information of the first modification request and the second modification request and the accept information of the second modification request. The acknowledgement log may be stored in the log data of the system. The log data may be, for example, the log data 318. The acknowledgment log may be maintained by the control engine 308.

At step 704, it may be determined if the attribute modification signal is generated. If the attribute modification signal is generated, the method 700 may proceed to step 706. If the attribute modification signal is not generated, the method 700 may repeat the step 704.

Further, at step 706, the acknowledgement log may be updated in response to the attribute modification signal having been generated. For instance, if the attribute modification signal corresponds to instructing the first node to modify the operating temperature of the furnace to 1000° C. is generated, the acknowledgement log may be updated to indicate that another modification request to modify operating temperature of the furnace to 1000° C. and the corresponding accept information.

At step 708, the updated acknowledgement log may be rendered to the first node and to the second node. The rendering of the updated acknowledgement log may enable operators to monitor about the attribute modification status. The rendering may be done on a display unit of the first node and/or the second node. In an example, the rendering may be, for example, by way of a interface, such as a Graphical User Interface (GUI). The steps 706 and 708 may be performed by the control engine 308.

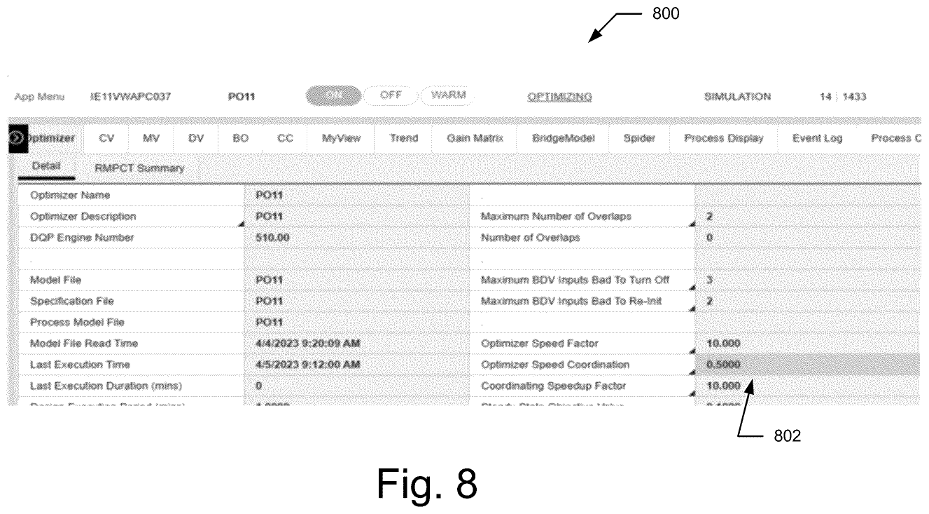

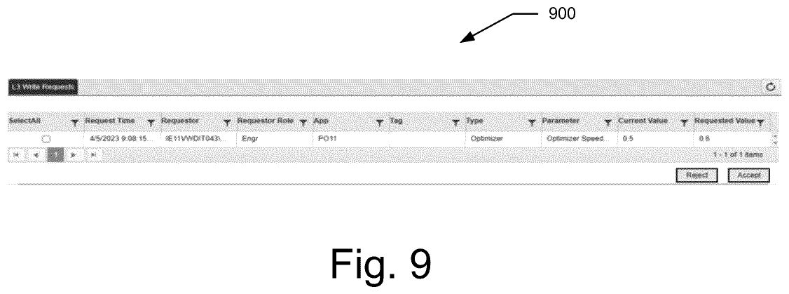

FIGS. 8 and 9 illustrate an interface for rendering an indication of the modification request, according to an example implementation of the present subject matter. For the sake of brevity, FIGS. 8 and 9 are explained in conjunction with each other. As illustrated in FIG. 8, when a user personnel in the ITN requests for modification of an asset attribute in the PCN, the modification request is indicated on the interface 800. In an example, the interface 800 may be a GUI provided on a display unit linked with the first node. In an example, the indication may provided with, for example, a change in a background colour of the asset attribute for which the modification request has been made. The indication may help the operator in easily identifying the modification request for the asset attribute. As is illustrated in FIG. 8, the modification request for “optimizer speed co-ordination” attribute has been updated and therefore, in the interface 800, the background colour of the asset attribute 802 is changed relative to the background colour of the other asset attributes, i.e., the attributes for which the modification request has not been raised.

As shown in FIG. 9, an operator linked with the first node may view the modification request details in an interface 900. In an example, the interface 900 may be a GUI provided on a display unit linked with the first node. In an example, the interface 900 may be similar to the interface 800. In an example, as can be seen in FIG. 9, the modification request details may include requestor details, requestor role, time-zone adjusted time, asset attribute, and current value of the attribute and requested value of the attribute. In an example, the interface 400 provides an option to reject or accept the modification request to the operator. In particular, the interface 900 may be provided in semi-auto accept mode or the manual mode of request-acceptance modes. The various details associate with the modification request provided in the interface may enable the operator to accept or reject the modification request based on the details provided. For instance, if the requestor is not in the list of authorized users corresponding to the industrial asset for which the attribute is to be modified, then the request may be rejected. Similarly, if the requested value of the attribute is not in range of acceptable values of the attribute, then the request may not be accepted. However, if details associated with the modification request are validated against the set of rules, such as a range of acceptable values for the attributes, a schedule for when modifications can be made, a list of authorized users, and a list of authorized devices, then the request may be accepted. In an example, the interfaces 800 and 900 may be rendered to the first node and/or the second node.

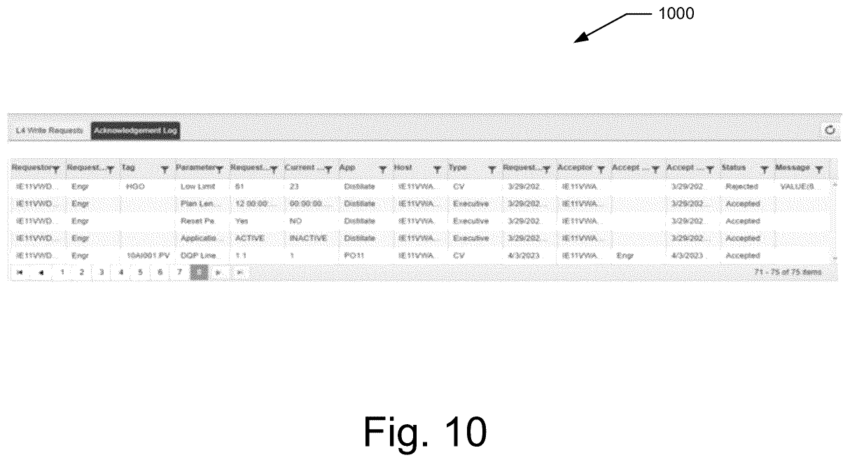

FIG. 10 illustrates an interface 1000 for rendering an acknowledgement log, according to an example implementation of the present subject matter. The interface 1000 may be similar to the interfaces 800, 900. The acknowledgement log may include an asset attribute modification request information, an accept t information, and a reject information. The acknowledgement log may further include details, such as requester information, request information, role of requester, an asset attribute information, input parameters, time record, and status information, such as reason of rejection, and the like. The operator may view all pending modification requests in the acknowledgement log. Once the acknowledgement log is updated in response to the generation of the attribute modification signal, the update acknowledgement log may be rendered to the first node and/or the second node.

In some examples, if a first request is not compliant with a predefined protocol that governs the modification of an attribute of an industrial asset, a revised request may be transmitted from the second node to modify the attribute of the industrial asset, as will be explained below.

FIG. 11 illustrates a method 1100 for inter-network communication, according to an example implementation of the present subject matter. The order in which the method 1100 is described is not intended to be construed as a limitation, and any number of the described method blocks may be combined in any order to implement the method 1100, or an alternative method. Furthermore, the method 1100 may be implemented by processor(s) or computing device(s) through any suitable hardware, non-transitory machine-readable instructions, or a combination thereof.

It may be understood that steps of the method 1100 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, the method 400 may be performed by the system 100, the system 200, or the system 300.

At step 1102, it may be determined if a first request from a second node in a second network is received. The first request may include a modification request for modifying the attribute of an industrial asset. The industrial asset may be linked to and/or controlled by the first node. The first network may be, for example, OTN and the second network may be, for example, ITN. The first network may correspond to the first network 104 or the OTN 104. The second network may correspond to the second network 106 or the ITN 206. The first node may correspond to, for example, the first node 108, or the first node 208. The second node may correspond to, for example, the second node 110 or the second node 210. For instance, assume that a conveyor belt in an industrial facility is controlled by the first node within the OTN. An engineer monitoring the status of the parameters corresponding to the conveyor belt through the second node in the ITN may want to change the speed of the conveyor belt, for example, to 2000 ft/min. Accordingly, the engineer may raise a request for modification of the speed of the conveyor belt through the second node.

Upon receiving the first request, an attribute associated with the industrial asset linked to the first node to be communicated by the second node may be determined. For instance, upon receiving the request for modification of an attribute associated with the conveyor belt from the second node, the attribute may be determined as the speed of the conveyor belt. In an example, the step 1102 may be performed by the control engine 308

If, at step 1102, it is determined that the first request has been received, the method 1100 may proceed to step 1104. If, at 1102, it is determined that the first request has not been received, the method 1100 may wait till the first request is received.

At step 1104, it may be determined if an acknowledgement message indicative of non-compliance of the first request is transmitted. Particularly, the first request may be authenticated to determine the compliance or non-compliance of the first request with predefined protocols. In an example, the predefined protocols may be established to permit modifications from the requesting node and may involve various security checks to prevent unauthorized access or changes to the industrial asset. For instance, it may be determined if the first request is in compliance with a predefined protocol to allow for modifying the speed of the conveyor belt to 2000 ft/min. If the first request is not compliant, the acknowledgement message indicative of non-compliance of the first request may be transmitted to the second node. If, at step 1104, it is determined that the acknowledgement message is transmitted, the method 1100 may proceed to step 1108. If, on the other hand, it is determined that the acknowledgement message indicative of non-compliance of the first request is not transmitted, the method 1100 may proceed to step 1110. In other words, if it is determined that the acknowledgement message indicative of non-compliance of the first request is not transmitted, it is indicative that the first request is compliant with the predefined protocols and the first request may be processed to modify the attribute of the industrial asset. In other words, the first request may be processed to modify the speed of the conveyor belt to 2000 ft/min. The step 1104 may be performed by the control engine 308 and the input validation engine 310.

At step 1108, a second request from the second node may be received. The second request may be a revised version of the first request. The second request may be adjusted to ensure compliance with the predefined protocol, thereby addressing the reasons for the non-compliance of the first request. For instance, the second request may still be to modify the speed of the conveyor belt to 2000 ft/min but complying with the predefined protocols. Subsequently, the second request may be authenticated to ensure compliance of the second request with the predefined protocols. The step 1108 may be performed by the control engine 308 and the input validation engine 310.

At step 1110, either in response to compliance of the first request or in response to the compliance of the second request with the predefined protocols, an attribute modification signal may be generated. The attribute modification signal may permit the modification of the attribute of the industrial asset. For instance, in response to the compliance of the first request or the second request for the modification of the speed of the conveyor belt to 2000 ft/min, the attribute modification signal permitting may be generated. The attribute modification signal may include instructions to the first node for the modification of the speed of the conveyor belt to 2000 ft/min. The step 1110 may be performed by, for example, the control engine 308.

At step 1112, the attribute modification signal may be transmitted to the first node instructing the first node to modify the attribute of the industrial asset. For instance, the attribute modification signal instructing the first node for the modification of the speed of the conveyor belt to 2000 ft/min may be transmitted to the first node. The first node may subsequently modify the speed of the conveyor belt to 2000 ft/min.

In an example, at step 1114, an acknowledgement log may be updated in response to the attribute modification signal having been generated. For instance, if the attribute modification signal corresponds to instructing the first node to modify the speed of the conveyor belt to 2000 ft/min is generated, the acknowledgement log may be updated to indicate that the speed of the conveyor belt is changed to 2000 ft/min. Further, the updated acknowledgement log may be transmitted to the first node and to the second node. The transmission of the updated acknowledgement log may enable operators to monitor about the attribute modification status. The step 1114 may be performed by the control engine 308.

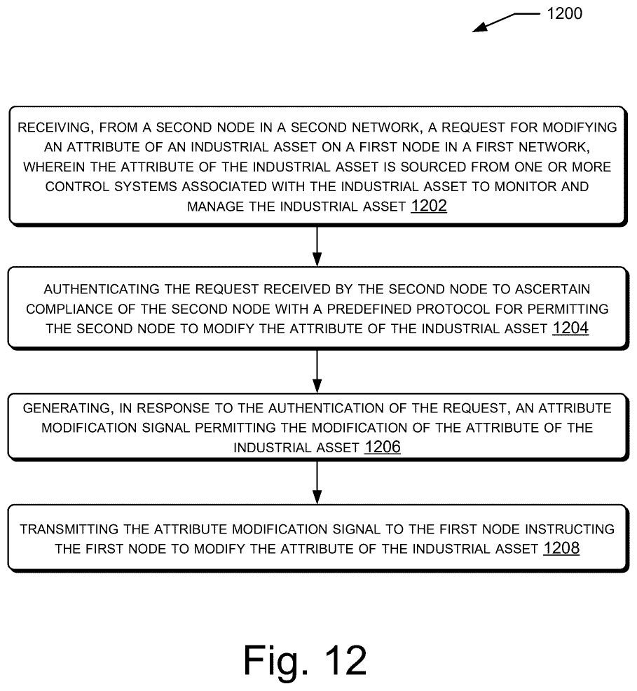

FIG. 12 illustrates a method 1200 for inter-network communication, according to an example implementation of the present subject matter. The order in which the method 1200 is described is not intended to be construed as a limitation, and any number of the described method blocks may be combined in any order to implement the method 1200, or an alternative method. Furthermore, the method 1200 may be implemented by processor(s) or computing device(s) through any suitable hardware, non-transitory machine-readable instructions, or a combination thereof.

It may be understood that steps of the method 1200 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, some of the steps of the method 1200 may be performed by the system 100, the system 200, or the system 300.

At step 1202, the method 1100 may include receiving, from a second node in a second network, a request for modifying an attribute of an industrial asset on a first node in a first network. The attribute of the industrial asset may be sourced from one or more control systems associated with the industrial asset to monitor and manage the industrial asset. The attribute may be indicative of at least one parameter associated with at least one of an operation, identification, and performance of the industrial asset. The first network may correspond to the first network 104 or the OTN 204. The second network may correspond to the second network 106 or the ITN 206. The first node may correspond to the first node 108 or the first node 208. The second node may correspond to the second node 110 or the second node 210.

At step 1204, the request received by the second node may be authenticated to ascertain compliance of the second node with a predefined protocol for permitting the second node to modify the attribute of the industrial asset. At step 1206, an attribute modification signal permitting the modification of the attribute of the industrial asset may be generated. The attribute modification signal may be generated in response to the authentication of the request.

At step 1208, the attribute modification signal may be transmitted to the first node instructing the first node to modify the attribute of the industrial asset.

In an example, in response to the authentication of the request, the method 1200 may include validating the request against a set of rules to determine the syntax of the request for modifying the attribute. The set of rules may include at least one of a range of acceptable values for the attributes, a schedule for when modifications can be made, a list of authorized users, and a list of authorized devices.

In an example, to validate the request, the method 1200 may include parsing the modification request to determine an input parameter therein and verifying the input parameter against the set of rules. Further, to validate the request, the method 1200 may include identifying an unsafe character in the request. Further, the method 1200 may include sanitizing the request for removing the unsafe character from the request.

In an example, to generate the attribute modification signal, the method 1200 may include identifying a request-acceptance mode for processing the request for modifying the at least one attribute of the industrial asset. The request-acceptance mode may be identified from one of a manual mode, an auto-accept mode, and a semi-auto-accept mode.

In response to identifying the request-acceptance mode as the semi-auto-accept mode, the method 1200 may include automatically accepting the modification request for modifying the at least one attribute of the industrial asset in the semi-auto accept mode after lapse of a predetermined time-period.

The method 1200 may include maintaining an acknowledgement log for the industrial asset. The acknowledgement log may include at least one of an asset attribute modification request information, an accept information, and a reject information. Further, the method 1200 may include updating, in response to the attribute modification signal having been generated, the acknowledgement log. In addition, the method 1200 may include rendering the updated acknowledgement log to at least one of the first node and the second node.

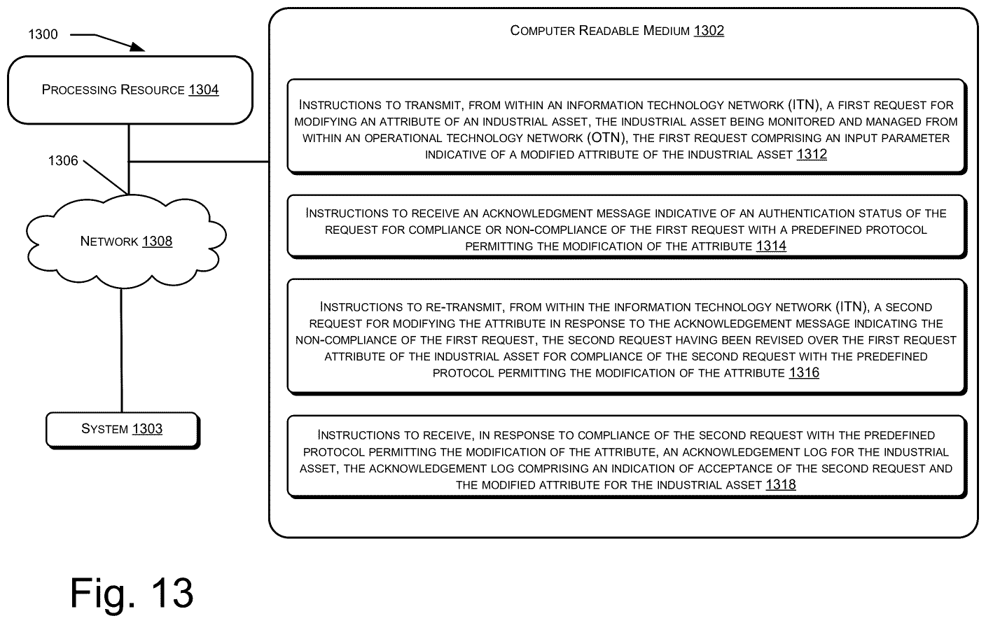

FIG. 13 illustrates a computing environment 1300, implementing a non-transitory computer-readable medium for obtaining signed certificates for on-premise devices, according to an example implementation of the present subject matter.

In an example, the non-transitory computer-readable medium 1302 may be utilized by the system 1303. The system 1303 may correspond to the system 100, the system 200, or the system 300. The system 1303 may be implemented in a public networking environment or a private networking environment. In an example, the computing environment 1300 may include a processing resource 1304 communicatively coupled to the non-transitory computer-readable medium 1302 through a communication link 1306.

In an example, the processing resource 1304 may be implemented in a device, such as the system 1303. The non-transitory computer-readable medium 1302 may be, for example, an internal memory device of the system 1303 or an external memory device. In an implementation, the communication link 1306 may be a direct communication link, such as any memory read/write interface. In another implementation, the communication link 1306 may be an indirect communication link, such as a network interface. In such a case, the processing resource 1304 may access the non-transitory computer-readable medium 1302 through a network 1308. The network 1308 may be a single network or a combination of multiple networks and may use a variety of different communication protocols. The processing resource 1304 and the non-transitory computer-readable medium 1302 may also be communicatively coupled to the system 1303 over the network 1308.

In an example implementation, the non-transitory computer-readable medium 1302 includes a set of computer-readable instructions for inter-network communication. The set of computer-readable instructions can be accessed by the processing resource 1304 through the communication link 1306 and subsequently executed to perform acts to provide feedback to the actuating object.

Referring to FIG. 13, in an example, the non-transitory computer-readable medium 1302 includes instructions 1312 to transmit, from within an information technology network (ITN), a first request for modifying an attribute of an industrial asset, the industrial asset being monitored and managed from within an operational technology network (OTN). The first request may include an input parameter indicative of a modified attribute of the industrial asset. The attribute may be indicative of at least one parameter associated with at least one of an operation, identification, and performance of the industrial asset. The ITN may correspond to the ITN 206 or the second network 106. The OTN may correspond to the OTN 204 or the first network 104.

The non-transitory computer-readable medium 1302 includes instructions 1314 to receive an acknowledgment message indicative of an authentication status of the request for compliance or non-compliance of the first request with a predefined protocol permitting the modification of the attribute.

The non-transitory computer-readable medium 1302 includes instructions 1316 to re-transmit, from within the information technology network (ITN), a second request for modifying the attribute in response to the acknowledgement message indicating the non-compliance of the first request. The second request having been revised over the first request attribute of the industrial asset for compliance of the second request with the predefined protocol permitting the modification of the attribute.

The non-transitory computer-readable medium 1302 includes instructions 1318 to receive, in response to compliance of the second request with the predefined protocol permitting the modification of the attribute, an acknowledgement log for the industrial asset. The acknowledgement log may include an indication of acceptance of the second request and the modified attribute for the industrial asset.

In the non-transitory computer-readable medium 1302, the predefined protocol may include security measures for authenticating the first request and the second request.

The non-transitory computer-readable medium 1302 includes instructions to validate the first request and the second against a set of rules to determine the syntax of the modification request. The set of rules may include at least one of a range of acceptable values for the attributes, a schedule for when modifications can be made, a list of authorized users, and a list of authorized devices.

The non-transitory computer-readable medium 1302 includes instructions to parse the first request and the second request to determine an input parameter therein. Further, the non-transitory computer-readable medium 1302 includes instructions to verify the input parameter against the set of rules.

In an example, to validate the second request, the non-transitory computer-readable medium 1302 includes instructions to identify an unsafe character in the second request and to sanitize the modification request for removing the unsafe character from the second request.

To generate the attribute modification signal, the non-transitory computer-readable medium 1302 includes instructions to identify a request-acceptance mode for processing the modification request for updating the attribute of the industrial asset. The request-acceptance mode may be identified from one of a manual mode, an auto-accept mode, and a semi-auto-accept mode. In response to identifying the request-acceptance mode as the semi-auto-accept mode, the non-transitory computer-readable medium 1302 includes instructions to automatically accept the modification request for updating the attribute of the industrial asset in the semi-auto accept mode after lapse of a predetermined time-period. The non-transitory computer-readable medium 1302 includes instructions to maintain the acknowledgement log for the industrial asset and to render the updated acknowledgement log to at least one of the first node and the second node.

The present subject matter thus provides secure techniques for modifications in the industrial assets using authentication-based writes from the ITN to the OTN. An operator device in the OTN may approve the asset attribute modification requests made by set of nodes from ITN upon successful authentication, thereby ensuring accountability of the asset. The acknowledgement log in the present subject matter may record modification request information, acceptances, and rejections, thereby creating an audit trail. The acknowledgement log may be used for tracking changes, troubleshooting issues, and ensuring accountability for modifications made to the industrial asset's attributes. Further, the present subject matter provides techniques for digitization of modifications to asset attributes from ITN to OTN, thus enhancing the auditability of the technique. In addition, the operator device may time the acceptance of the modification request based on underlying industrial process conditions. The present techniques may thus be capable of allowing secure, timely, and robust control and optimization of assets in a topology in which different networks, such as the OTN and the ITN are interconnected.

Although examples and implementations of present subject matter have been described in language specific to structural features and/or methods, it is to be understood that the present subject matter is not necessarily limited to the specific features or methods described. Rather, the specific features and methods are disclosed and explained in the context of a few example implementations of the present subject matter.

What is claimed is:

1. A system comprising:
a processor to:
determine, in response to initiation of a transaction between a first node in a first network and a second node in a second network, an attribute associated with an industrial asset linked to the first node to be communicated to the second node, wherein the attribute includes at least one of an identification parameter, an operational parameter, and an optimization parameter of the industrial asset, the transaction comprising a modification request for modifying the attribute of the industrial asset from the second node;
authenticate the transaction initiated by the second node to ascertain compliance of the second node with a predefined protocol for permitting the second node to modify the attribute of the industrial asset;
generate, in response to the authentication of the transaction, an attribute modification signal permitting the modification of the attribute of the industrial asset; and
transmit the attribute modification signal to the first node instructing the first node to modify the attribute of the industrial asset.

2. The system of claim 1, wherein the first network is an operational technology network (OTN) and the second network is an information technology network (ITN).

3. The system of claim 1, wherein the processor is to validate the modification request against a set of rules to determine the syntax of the modification request, wherein the set of rules comprises at least one of a range of acceptable values for the attributes, a schedule for when modifications can be made, a list of authorized users, and a list of authorized devices.

4. The system of claim 3, wherein the processor is to:
parse the modification request to determine an input parameter therein; and
verify the input parameter against the set of rules.

5. The system of claim 3, wherein to validate the modification request, the processor is to:
identify an unsafe character in the modification request; and
sanitize the modification request for removing the unsafe character from the modification request.

6. The system of claim 1, wherein to generate the attribute modification signal, the processor is to identify a request-acceptance mode for processing the modification request for updating the attribute of the industrial asset, wherein the request-acceptance mode is identified from one of a manual mode, an auto-accept mode, and a semi-auto-accept mode.

7. The system of claim 6, wherein, in response to identifying the request-acceptance mode as the semi-auto-accept mode, the processor is to automatically accept the modification request for updating the attribute of the industrial asset in the semi-auto accept mode after lapse of a predetermined time-period.

8. The system of claim 1, wherein the processor is to:
maintain an acknowledgement log for the industrial asset, the acknowledgement log comprising at least one of an asset attribute modification request information, an accept information, and a reject information;
update, in response to the attribute modification signal having been generated, the acknowledgement log; and
render the updated acknowledgement log to at least one of the first node and the second node.

9. A method comprising:
receiving, from a second node in a second network, a request for modifying an attribute of an industrial asset on a first node in a first network, wherein the attribute of the industrial asset is sourced from one or more control systems associated with the industrial asset to monitor and manage the industrial asset;
authenticating the request received by the second node to ascertain compliance of the second node with a predefined protocol for permitting the second node to modify the attribute of the industrial asset;
generating, in response to the authentication of the request, an attribute modification signal permitting the modification of the attribute of the industrial asset; and
transmitting the attribute modification signal to the first node instructing the first node to modify the attribute of the industrial asset.

10. The method of claim 9, wherein the attribute is indicative of at least one parameter associated with at least one of an operation, identification, and performance of the industrial asset.

11. The method of claim 9, wherein the first network is an information technology network (ITN) and the second network is an operational technology network (OTN).

12. The method of claim 9, wherein in response to the authentication of the request, the method comprises:
validating the request against a set of rules to determine the syntax of the request for modifying the attribute, wherein the set of rules comprises at least one of a range of acceptable values for the attributes, a schedule for when modifications can be made, a list of authorized users, and a list of authorized devices.

13. The method of claim 12, wherein to validate the request, the method comprises:
parsing the modification request to determine an input parameter therein; and
verifying the input parameter against the set of rules.

14. The method of claim 9, wherein to validate the request, the method comprises:
identifying an unsafe character in the request; and
sanitizing the request for removing the unsafe character from the request.

15. The method of claim 9, wherein to generate the attribute modification signal, the method comprises:
identifying a request-acceptance mode for processing the request for modifying the at least one attribute of the industrial asset, wherein the request-acceptance mode is identified from one of a manual mode, an auto-accept mode, and a semi-auto-accept mode.

16. The method of claim 15, wherein in response to identifying the request-acceptance mode as the semi-auto-accept mode, the method comprises:
automatically accepting the modification request for modifying the at least one attribute of the industrial asset in the semi-auto accept mode after lapse of a predetermined time-period.

17. The method of claim 9, wherein the method comprises:
maintaining an acknowledgement log for the industrial asset, the acknowledgement log comprising at least one of an asset attribute modification request information, an accept information, and a reject information;
updating, in response to the attribute modification signal having been generated, the acknowledgement log; and
rendering the updated acknowledgement log to at least one of the first node and the second node.

18. A non-transitory computer-readable medium comprising instructions, the instructions being executable by a processing resource to:
transmit, from within an information technology network (ITN), a first request for modifying an attribute of an industrial asset, the industrial asset being monitored and managed from within an operational technology network (OTN), the first request comprising an input parameter indicative of a modified attribute of the industrial asset;
receive an acknowledgment message indicative of an authentication status of the request for compliance or non-compliance of the first request with a predefined protocol permitting the modification of the attribute;
re-transmit, from within the information technology network (ITN), a second request for modifying the attribute in response to the acknowledgement message indicating the non-compliance of the first request, the second request having been revised over the first request attribute of the industrial asset for compliance of the second request with the predefined protocol permitting the modification of the attribute; and
receive, in response to compliance of the second request with the predefined protocol permitting the modification of the attribute, an acknowledgement log for the industrial asset, the acknowledgement log comprising an indication of acceptance of the second request and the modified attribute for the industrial asset.

19. The non-transitory computer-readable medium of claim 18, wherein the attribute is indicative of at least one parameter associated with at least one of an operation, identification, and performance of the industrial asset.

20. The non-transitory computer-readable medium of claim 18, wherein the predefined protocol includes security measures for authenticating the first request and the second request.
